(19) United States
(12) Patent Application Publication
(10) Pub. No.: US 2007/0271867 A1
(43) Pub. Date: Nov. 29, 2007

(54) REFRACTORY TILES FOR HEAT EXCHANGERS

(75) Inventors: Wade A. Taber, Charlton, MA (US); Joseph L. Ouellet, Brookfield, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN CERAMICS & PLASTICS, INC., Worcester, MA (US)

(21) Appl. No.: 11/750,890

(22) Filed: May 18, 2007

Related U.S. Application Data
(60) Provisional application No. 60/802,093, filed on May 19, 2006.

(51) Int. Cl. F27D 1/00

(52) U.S. Cl. 52/506.03

(57) ABSTRACT

A refractory tile system is provided that includes a plurality of tiles adapted for assembly to cover the wall of the boiler. Each tile includes a main body has a front surface and a back surface and includes silicon carbide and a metallic phase including silicon. Each tile also includes an engagement structure with an engagement void for receiving a complementary stud structure extending from the wall of the boiler. Each tile also includes a void plane defined by a plurality of points within the engagement void that are closest to the front surface, and a hot face plane parallel to the void plane defined by a plurality of points on the front surface closest to the void plane, and Dₛ≧0.25 Tₐ, where Dₛ is the shortest distance between the void plane and the hot face plane and Tₐ is the average thickness of the main body.

### CROSS-REFERENCE TO RELATED APPLICATION(S)

The following disclosure is a non-provisional application which claims priority to U.S. Provisional Application No. 60/802,093 filed May 19, 2006, entitled “Refractory Tiles for Heat Exchangers” and having named inventors Wade A. Taber and Joseph L. Ouellet, which application is incorporated by reference herein in its entirety.

### BACKGROUND

1. Field of the Disclosure

The present disclosure is related generally to refractory tiles and particularly directed to thermally conductive tiles for use in waste-to-energy systems.

2. Description of the Related Art

It has been common practice to cover furnace walls of facilities such as municipal waste incinerators with a firebrick, cements or tile sheath in order to protect the structural elements from erosive and corrosive effects of combustion. Many of these facilities now include energy recovery systems, often referred to as waste-to-energy systems (or WTE systems), which operate to retrieve the heat generated during the combustion process. In many cases, the energy recovery systems utilize a boiler that can include an array of tubes placed at the periphery of the furnace or incinerator, typically in the walls, through which a fluid such as water is circulated as a heat transfer medium. Given the harsh environment of the furnace, it is desirable to protect the heat exchanger array with a refractory material. However, unlike typical thermally insulating refractory bricks used in common furnaces, the refractory tiles that line a heat exchanger are intended to conduct heat.

In addition to the unique thermal characteristics, the attachment mechanisms of such refractory tiles are often different than standard furnace bricks in order to position the refractory tiles close to the heat exchanger. In the past, attachment mechanisms of the tiles have included hanging the bricks from metallic support shoes, or from vertical I-beams using J-shaped bolt anchors. Other mechanisms include tongue and groove mating elements utilizing a vertical metal framework. More recently, the attachment mechanisms have been made such that the refractory tiles or bricks can be attached to the wall heat exchanger array itself.

Among the many methods for hanging protective refractory brick on an array of heat exchanger tubing, one method includes hanging the refractory tiles from a bolt extending into the tile and anchoring the tile to the wall of the heat exchanger. This technique, while relatively inexpensive, subjects the brick to compressive stresses, which leads to the development of cracks and ultimately, to failure of the brick. In response to these particular problems, different anchoring mechanisms have been investigated. For example, a proprietary sunken anchor slot mechanism was designed wherein an anchoring receptacle in the shape of a “T” was formed within the body of the brick to secure the brick to a T-shaped anchor extending from the tubing wall of the heat exchanger. See, U.S. Pat. No. 5,243,801.

Despite continued improvements in refractory tile systems for WTE applications, the industry continues to demand improved designs and particularly, improved durability, efficiency, safety, and repair ease.

### SUMMARY

According to one aspect, a refractory tile system for covering a wall of a boiler is disclosed that includes a plurality of tiles adapted for assembly to cover the wall of the boiler. Each tile includes a main body having a front surface and a back surface, wherein the main body comprises a composite including silicon carbide and a metallic phase including silicon, and each tile also includes a first engagement structure extending from the back surface of the tile and having a first engagement void for receiving a complementary stud structure extending from the wall of the boiler. Each tile also includes a void plane defined by a plurality of void points, wherein the void points are points within the first engagement void that are closest to the front surface and extend along the first engagement void. Each tile also includes a hot face plane parallel to the void plane and defined by a plurality of hot face points, each hot face point being a point on the front surface closest to the void plane, wherein Dₛ≧0.25 Tₐ, Dₛ being shortest distance between the void plane and the hot face plane and Tₐ being the average thickness of the main body.

According to another aspect, a refractory tile system for covering a wall of a boiler is disclosed that includes a plurality of tiles adapted for assembly to cover the wall of the boiler, such that each tile includes a main body having a front surface and a back surface, wherein the main body is a composite material including silicon carbide and a metallic phase including silicon. The front surface of each tile has an average profile variation (Pₐ) of not greater than about 0.75 mm. Additionally, each tile has an engagement structure extending from the back surface of the tile and having an engagement void for receiving a complementary stud structure extending from the wall of the boiler.

According to one aspect, a refractory tile system for covering a wall of a boiler is disclosed that includes a plurality of tiles adapted for assembly to cover the wall of the boiler. Each tile includes a main body having a front surface and a back surface, wherein the main body has a thermal conductivity of not less than about 18 W/mK at 1200° C., and each tile also includes first and second engagement structures extending from the back surface of the tile and having respective first and second engagement voids for receiving complementary stud structures extending from the wall of the boiler. Each tile also includes a void plane defined by a plurality of void points, wherein the void points are points within the first and second engagement voids that are closest to the front surface and extend along the first and second engagement voids. Each tile also includes a hot face plane parallel to the void plane and defined by a plurality of hot face points, each hot face point being a point on the front surface closest to the void plane, wherein Dₛ≧0.25 Tₐ, Dₛ being shortest distance between the void plane and the hot face plane and Tₐ being the average thickness of the main body.

According to one aspect, a refractory tile system for covering a wall of a boiler is disclosed that includes a plurality of tiles adapted for assembly to cover the wall of the boiler. Each tile includes a main body having a front surface and a back surface and each tile also includes first and second engagement structures extending from the back surface of the tile and having respective first and second engagement voids for receiving complementary stud structures extending from the wall of the boiler. Each tile also includes a void plane defined by a plurality of void points, wherein the void points are points within the first and second engagement voids that are closest to the front surface and extend along the first and second engagement voids. Each tile also includes a hot face plane parallel to the void plane and defined by a plurality of hot face points, each hot face point being a point on the front surface closest to the void plane, wherein Dₛ≧0.25 Tₐ, Dₛ being shortest distance between the void plane and the hot face plane and Tₐ being the average thickness of the main body.

### BRIEF DESCRIPTION OF THE DRAWINGS

The present disclosure may be better understood, and its numerous features and advantages made apparent to those skilled in the art by referencing the accompanying drawings.

FIG. 1 is a cross sectional view of a prior art contoured refractory tile system.

FIG. 2A is a cross sectional view of a refractory tile system according to one embodiment.

FIG. 2B is an illustration of an engagement structure and complementary stud structure according to one embodiment.

FIG. 2C is a plan view of the back surface of a refractory tile and engagement structures according to one embodiment.

FIG. 3 is a cross sectional view of a refractory tile system according to one embodiment.

FIG. 4 is a cross sectional view of a refractory tile system according to one embodiment.

FIG. 5 is a perspective view of a plurality of refractory tiles assembled next to heat exchanger pipes according to one embodiment.

FIG. 6 is a plan view of the back surface of a refractory tile and an engagement structure according to one embodiment.

FIG. 7A is a plan view of the back surface of a refractory tile and an engagement structure according to one embodiment.

FIG. 7B is a side view of a refractory tile and an engagement structure according to one embodiment.

The use of the same reference symbols in different drawings indicates similar or identical items.

### DESCRIPTION OF THE EMBODIMENT(S)

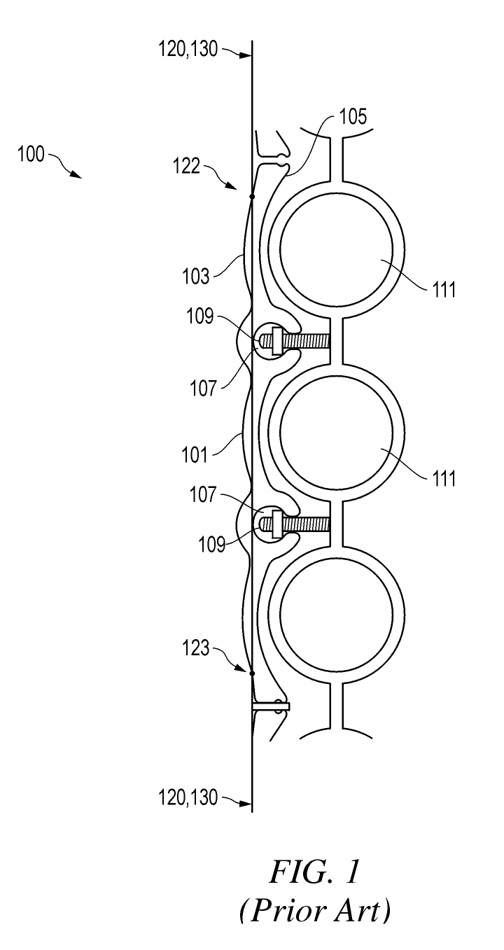

Referring to FIG. 1, a cross sectional view of a prior art refractory tile system 100 is illustrated. As can be seen, the refractory tile 101 has a front surface 103 and a back surface 105, both of which are contoured. Contouring the surfaces is common and is typically done to place the refractory tiles in close proximity to the pipes as well as increase the surface area coverage of the pipes by the refractory tile to facilitate efficient heat transfer. The front surface 103 is generally referred to as a hot surface because it is proximate to the direct heat from the incinerator. The back surface 105 is generally referred to as a cold surface because it is not subject to direct heat like the front surface 103 and thus is generally cooler than the front surface 103. Also illustrated in the prior art refractory tile are voids 107, in the form of channels in the back surface of the refractory tile that extend into the main body of the tile and extend along the entire length of the tile. The voids are used to engage anchors 109 extending from the wall between the pipes 111.

According to the prior art refractory tile system 100, the tiles are stacked in an array. Because the voids 107 extend in a vertical direction along the entire vertical length of each tile and because the voids 107 are open at opposite ends, the tiles are restrained vertically by a secondary structure, such as a series of horizontal rails (not shown) and/or the floor of the furnace. The void/anchor arrangement only restrains the tiles horizontally (laterally).

Referring now to present embodiments, a refractory tile system for covering a wall of a boiler is disclosed that includes a plurality of tiles adapted for assembly to cover the wall of the boiler. According to one embodiment, each tile includes a main body having a front surface and a back surface, wherein the main body comprises a composite including silicon carbide and a metallic phase including silicon. Each tile also includes first and second engagement structures extending from the back surface of the tile and having respective first and second engagement voids for receiving complementary stud structures extending from the wall of the boiler. Each tile also includes a void plane defined by a plurality of void points, wherein the void points are points within the first and second engagement voids that are closest to the front surface and extend along the first and second engagement voids. Each tile also includes a hot face plane parallel to the void plane and defined by a plurality of hot face points, each hot face point being a point on the front surface closest to the void plane, wherein Dₛ≧0.25 Tₐ, Dₛ being shortest distance between the void plane and the hot face plane and Tₐ being the average thickness of the main body.

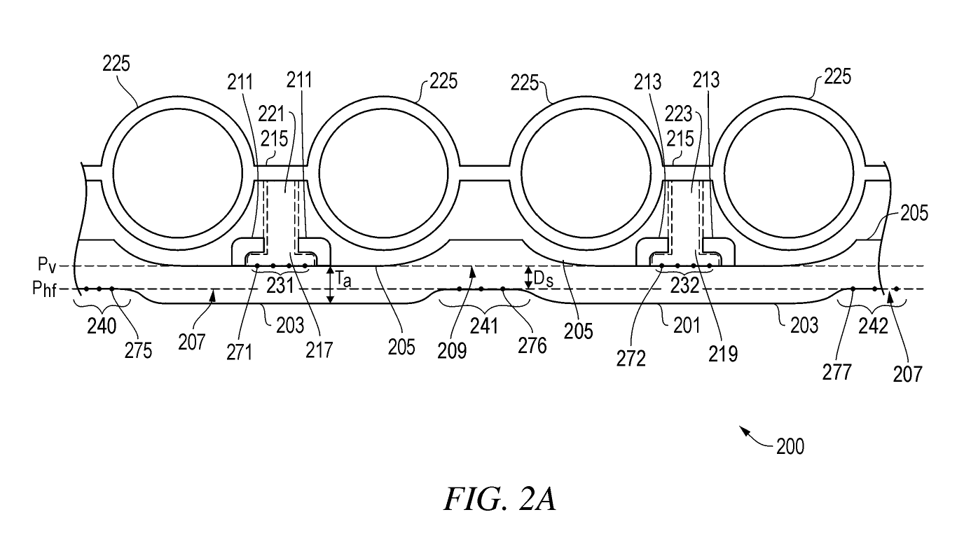

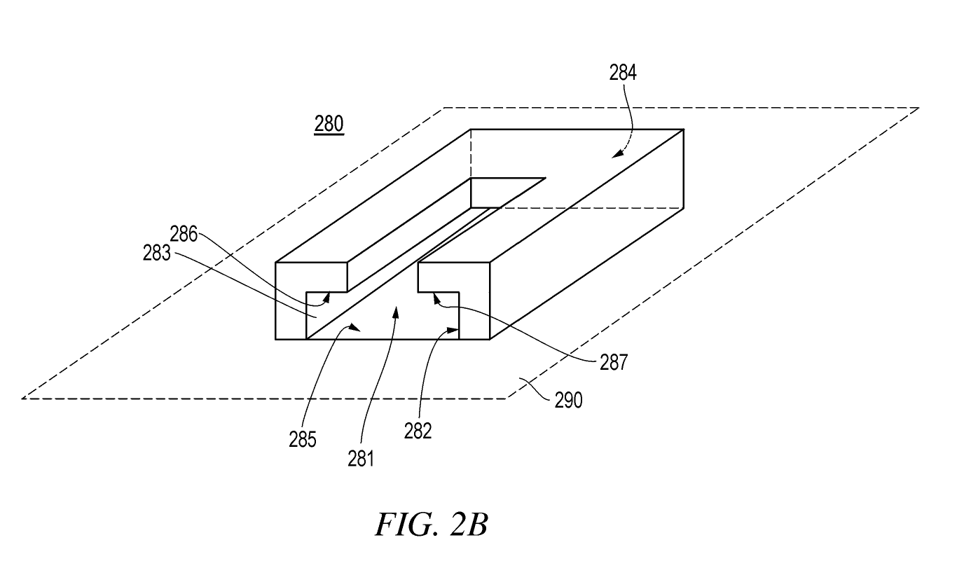

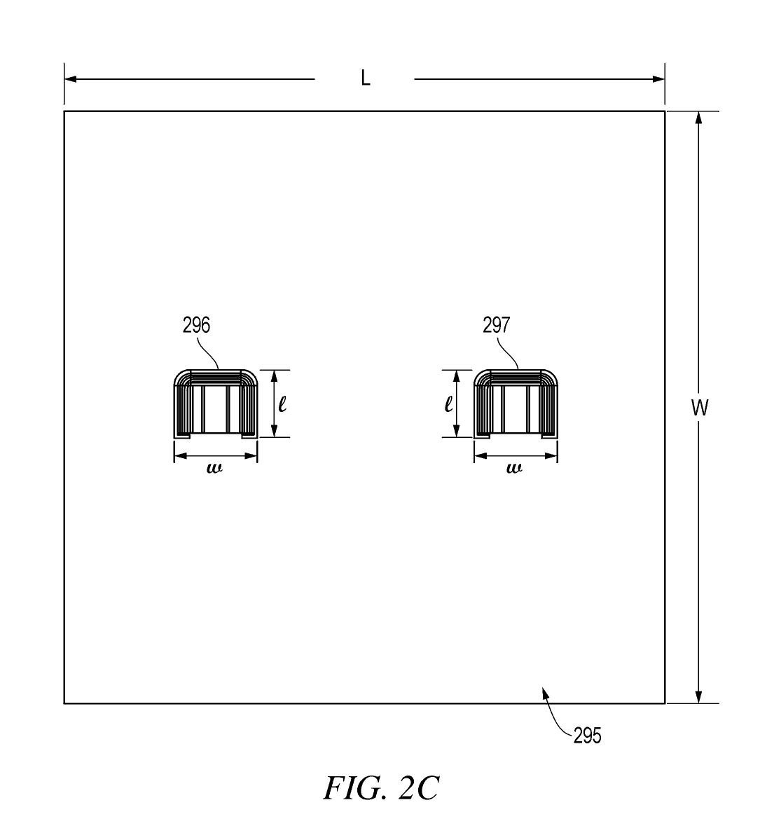

Referring to FIG. 2, a cross sectional view of a refractory tile and boiler pipe system 200 is illustrated according to one embodiment. The refractory tile 201 can be made of a thermally conductive refractory ceramic material. According to one embodiment, the refractory tile 201 can include not less than about 80 wt % silicon carbide, such as not less than about 85 wt % silicon carbide. According to another embodiment, the refractory tile 201 can include not less than about 90 wt % silicon carbide, such as not less than about 95 wt % silicon carbide.

According to one embodiment, the refractory tile 201 can be a composite material including a metallic phase, such as metal silicon, oftentimes elemental silicon. According to one embodiment, the body of the refractory tile 201 can include not greater than about 30 wt % silicon, such as not greater than about 25 wt % silicon, or not greater than about 20 wt % silicon, or still, not greater than about 15 wt % silicon. According to a particular embodiment, the body of the refractory tile 201 can include an amount of silicon within a range of between about 4.0 wt % silicon and 25 wt % silicon, such as within a range of between about 5.0 wt % to about 20 wt %, and in particular within a range of between about 6 wt % to 20 wt %.

Still, the silicon content can be reduced given the processing of the refractory tile material, including for example, in situ reaction of free silicon with free carbon in a silicon carbide-based body. As such, in one particular embodiment, the body includes a silicon reaction bonded silicon carbide composition (i.e., Si/SiC/SiC), such that the silicon content is not greater than about 3.0 wt %, or not greater than about 2.0 wt %, or even not greater than about 1.0 wt % silicon. In a particular embodiment, the body of the refractory tile 201 can have a silicon content within a range of between about 0.05 wt % and about 3.0 wt % silicon, such as within a range of between about 0.05% and about 1.0 wt % silicon.

In further reference to the material of the refractory tile 201, according to another embodiment, the body of the tile includes a material having a thermal conductivity of not less than about 18 W/mK at 1200° C., such as not less than about 20 W/mK at 1200° C., or not less than about 25 W/mK at 1200° C. Still, in another embodiment, the thermal conductivity of the tile material is greater, such as not less than about 30 W/mK at 1200° C., or not less than about 35 W/mK at 1200° C. Materials meeting certain characteristics discussed above include ADVANCER® CN-703, Nitride Bonded Silicon Carbide, CRYSTAR® RB, Reaction Bonded Silicon Carbide, SILIT® SK, Reaction Bonded Silicon Infiltrated Silicon Carbide (SiSiC).

In further reference to the characteristics of the refractory tile 201, the tile can be a dense material. According to one embodiment, the refractory tile 201 has a porosity of not greater than about 5.0 vol %, such not greater than about 3.0 vol %, or still, not greater than about 1.0 vol %. In one particular embodiment, the porosity of the refractory tile 201 is less than 1.0 vol %.

As stated above, the refractory tile 201 can be a dense material, and in addition to the porosities described above, according to one embodiment the bulk density of the material is not less than about than about 2.85 g/cm³. In another embodiment, the material comprising the main body has a bulk density of not less than about 2.90 g/cm³, such as not less than about 2.95 g/cm³, or not less than about 3.00 g/cm³. Such density provides a durable refractory tile that can have enhanced mechanical and chemical resistance, thereby improving the thermal conductivity of the tile and the operable lifetime.

The main body of the refractory tile 201 can generally be described as the material between the front surface 203 and the back surface 205. As illustrated in FIG. 2A, the main body can have a contour and as such, in describing the thickness of the refractory tile 201, a measure of average thickness (Tₐ) is appropriate. For clarification, the average thickness (Tₐ) is an average of the measured distance between the front surface 203 and the back surface 205 over a length of the tile. Generally, the main body of the refractory tiles 201 can have an average thickness that is not greater than about 30 mm, such as not greater than about 20 mm. Still, according to one embodiment, the average thickness can be less, such as not greater than about 15 mm, or not greater than about 12 mm. Generally the average thickness of the refractory tiles 201 is not less than about 3.0 mm, such as not less than about 5.0 mm, or not less than about 7.0 mm.

In addition to the features provided above, the refractory tile 201 of FIG. 2A also has engagement structures 211 and 213 for attaching the refractory tile 201 to the wall of the boiler 215. As described above, the engagement structures 211 and 213 can extend from the back surface 205 of the refractory tile 201 and can have engagement voids 217 and 219 for engaging complementary stud structures 221 and 223 that extend from the wall of the boiler 215. The complementary stud structures 221 and 223 can include one or more parts, such as a stud and an integrated or attached stud head, washer, nut or the like, designed to engage the engagement voids 217 and 219 of the engagement structures 211 and 213. According to one particular embodiment, each of the engagement structures 211 and 213 are configured to engage a single complementary stud structure 221 and 223. Engagement of a single complementary stud structure by a single engagement structure can allow for limited movement of a tile in some directions while allowing for freedom of movement in other directions. In particular, utilization of a tile having engagement structures configured to engage a single complementary stud can provide a floating anchoring point that allows for individual movement of the tile under thermal and mechanical stresses while not being coupled to another tile or secondary restraining system. Also, such an arrangement can allow for uniquely formed engagement structures and studs for different applications and purposes.

Accordingly, the engagement structures 211 and 213 can have a plurality of engagement surfaces for contacting and securing the complementary stud structures 221 and 223. Referring to FIG. 2B a particular engagement structure 280 is illustrated. As illustrated, the engagement structure 280 has an engagement void 281 that has a closed structure configured to receive a complementary stud structure (not illustrated). According to a particular embodiment, the engagement structure 280 can have plurality of engagement surfaces, such as at least three engagement surfaces 282, 283 and 284 that border the engagement void 281 and are configured to contact the complementary stud structure. Engagement surfaces 282 and 283 can be suitable for limiting the motion of the tile in a lateral direction, while engagement surface 284 is suitable for limiting the motion of the tile in a direction coaxial with the direction of the load exerted on the complementary stud structure by the weight of the tile directions (a vertical direction). Still, the engagement structure 280 can be configured to engage a complementary stud structure along multiple surfaces, such as four or more surfaces. In the illustrated embodiment, engagement surface 285, which according to one embodiment is a surface abutting the back surface of the tile 290, can limit motion of the tile away from the boiler wall in a direction normal to the plane of the back surface of the tile 290. Engagement surfaces 286 and 287 can also limit motion of the tile away from the boiler wall in a direction normal to the plane of the back surface of the tile 290. In such embodiments where limiting the motion of a tile in certain directions is desired, the engagement voids can be shaped to fit the complementary stud structures such that there are substantially no gaps between the engagement structure and the complementary stud structure.

Referring again to FIG. 2A, while movement of the tile in certain directions can be limited by the design of the engagement structures, the engagement structures 211 and 213 can be configured to allow some movement of the tile to relieve stresses arising during operation. According to one embodiment, the complementary stud structures 221 and 223 have a T-shaped cross-sectional contour and can be received into engagement voids 217 and 219 having a substantially similar shape (shown in part in FIG. 2B). Generally, the T-shaped engagement voids 217 and 219 and complementary stud structures 221 and 223 provide sufficient engagement surfaces to support the weight of the tile, while providing a single floating anchor point that allows each tile to move or shift during operation unlike and does not anchor the tile to an adjacent tile or other secondary structure. In particular, the T-shaped design allows for sufficient movement of the tile, while maintaining sufficient support of the weight of the tile and reducing the likelihood of the tile to disengage the stud structures.

In further reference to the engagement structures 211 and 213, as will be appreciated, each of the engagement structures 211 and 213 can be a load bearing structure and are configured to support at least a portion of the weight of the refractory tile 201. In one particular embodiment, the engagement structures 211 and 213 are configured to support at least about half of the weight of the refractory tile 201. According to one embodiment, each of the engagement structures 211 and 213 can support at least about 75% of the weight of the tile, and still, in other embodiments, each of the engagement structures 211 and 213 can support the full weight of the refractory tile 201. It will be appreciated that while FIG. 2A illustrates two engagement structures evenly spaced apart across the back surface 205 of the refractory tile 201, a greater or fewer number of engagement structures can be used depending upon the dimensions of the tile, the geometry of the boiler wall 215, and the spacing of the pipes 225.

In further reference to the engagement structures 211 and 213, according to one embodiment, the engagement structures 211 and 213 have discrete dimensions including a discrete length and width that is less than the length and width respectively of the refractory tile. For ease of reference, FIG. 2C is provided as a planar view of the back surface 295 of a refractory tile having engagement structures 296 and 297. As illustrated, the discrete length (l) and width (w) of each engagement structure 296 and 297 is provided as well as the length of the tile (L) and the width of the tile (W). According to one embodiment, the length (l) and width (w) of each engagement structure is not greater than about 50% of the length (L) and width (W) respectively of the refractory tile 201. Still, the engagement structures 296 and 297 can have smaller dimensions, such that the length (l) and width (w) of the engagement structures 296 and 297 is not greater than about 25% of the length (L) and width (W) respectively of the refractory tile, such as not greater than about 20%, or even not greater than about 15% of the length and width respectively of the refractory tile. Having engagement structures of a discrete length (l) and width (w) that is only a portion of the length (L) and width (W) of the tile facilitates anchoring the tile at a single point which can allow for movement of the tile about an anchoring point. It will be appreciated that while this particular embodiment illustrates two engagement structures 296 and 297, different numbers of engagement structures can be used, ranging from one, to an array of engagement structures spaced apart across the back surface 295 of the refractory tile.

The refractory tiles provided herein may have particular dimensions. Typically, the length (L) of the refractory tile is generally greater than about 10 cm. Other embodiments utilize larger refractory tiles, such that the length (L) is not less than about 15 cm, or not less than about 20 cm, or even not less than about 50 cm. Still, the length (L) of the refractory tile 601 is typically not greater than about 60 cm.

Referring again to FIG. 2A and the placement of the engagement structures 211 and 213, according to one embodiment, the engagement structures 211 and 215 can extend from the back surface 205 of the refractory tile 201 and do not extend into the main body of the refractory tile 201. As such, the engagement voids 217 and 219 of the engagement structures 211 and 213 can be disposed behind the main body, and particularly disposed behind the back surface 205 of the refractory tile 201, such that the voids do not extend into the main body of the refractory tile 201. As illustrated in FIG. 2A, portions of the back surface are contoured to follow the contour of the pipes 225, however, in such locations along the refractory tile 201 where the engagement structures 211 and 213 are fitted, the engagement voids 217 and 219 can be closer to the boiler wall 215 than the back surface 205. It can be desirable to have the engagement structures 211 and 215 extending from the back surface 205 such that the engagement voids 217 and 219 do not extend into the main body of the refractory tile 201.

Referring to other aspects of the above described embodiment, a void plane 209 (Pᵥ) and hot face plane 207 (P_{hf}) are provided. According to the first aspect, the void plane 209 is defined by a plurality of void points 271 and 272 that are located within the engagement voids 217 and 219 and are closest to the front surface 203. Such points extend within regions 231 and 232, since points along regions 231 and 232 are equidistant from the front surface as measured through the thickness of the main body of the refractory tile 201. It will be appreciated that in light of the specification and the figures herein, the term “closest” is understood to be a measurement through the thickness of the main body of the refractory tile 201 in a direction substantially normal to the planes and surfaces defined, and such points closest to the front surface may also be outside of the plane of FIG. 2A, along a length or vertical direction of the voids 217 and 219.

As illustrated in the particular embodiment shown in FIG. 2A, void plane 209 can extend along a portion of the back surface 205 and through portions of the main body of the refractory tile 201 where these portions of the tile have contours alternating from the contours in regions 231 and 232.

In further reference to the void plane 209 and hot face plane 207, as illustrated in FIG. 2A, the hot face plane 207 is a plane parallel to the void plane 209 and defined by a plurality of hot face points on the front surface 203 that are closest to the void plane 209. According to FIG. 2A, the hot face points 275, 276, and 277 (275-277) are those points on the front surface 203 within regions 240, 241 and 242, which are closest to the void plane 209 as measured through the thickness of the main body of the refractory tile 201. According to FIG. 2A, the hot face plane 207 extends through portions of the main body that have a contour deviating from the contour in regions 240-242. As such, the hot face plane 207 is defined by those points 275-277 that are in the deepest contours of the front surface 203 and closest to the back surface 205. As stated above, according to the embodiments herein, the distance between the void plane 209 and the hot face plane 207 Dₛ is greater than about 0.25 Tₐ. It should be clear that the hot face plane 207 and the void plane 209 are not the same plane, and indeed the void plane 209 lies behind (toward the back face) the hot face plane 207.

As indicated above and described in the first aspect, the shortest distance Dₛ between the void plane 209 and hot face plane 207 is greater than 0.25 Tₐ. According to other embodiments, Dₛ is greater than about 0.50 Tₐ, such as greater than about 0.75 Tₐ. Still, according to other embodiments, (one such illustrated and discussed below) the shortest distance between the void plane 209 and the hot face plane 207 is not less than the full measure of the average thickness of the main body, otherwise stated, Dₛ is not less than Tₐ. As such, the void plane 209 does not intersect any points on the front surface 203.

By way of comparison, referring to prior art FIG. 1, a void plane 120 extends through the main body and intersects points 122 and 123 on the front surface 103. Such points 122 and 123 are not only the locations at which the void plane 120 intersects the front surface 103, but also define the hot face plane 130. That is, points 122 and 123 are the points on the front surface 103 closest to the void plane 120; they intersect or lie in the void plane 120. Accordingly, the hot face plane 130 and the void plane 120 are the same plane.

According to another aspect, a refractory tile system for covering a wall of a boiler is disclosed that includes a plurality of tiles adapted for assembly to cover the wall of the boiler, such that each tile includes a main body having a front surface and a back surface, wherein the main body is a composite material including silicon carbide and a metallic phase including silicon. The front surface of each tile has an average profile variation (Pₐ) of not greater than about 0.75 mm. Additionally, each tile has an engagement structure extending from the back surface of the tile and having an engagement void for receiving a complementary stud structure extending from the wall of the boiler.

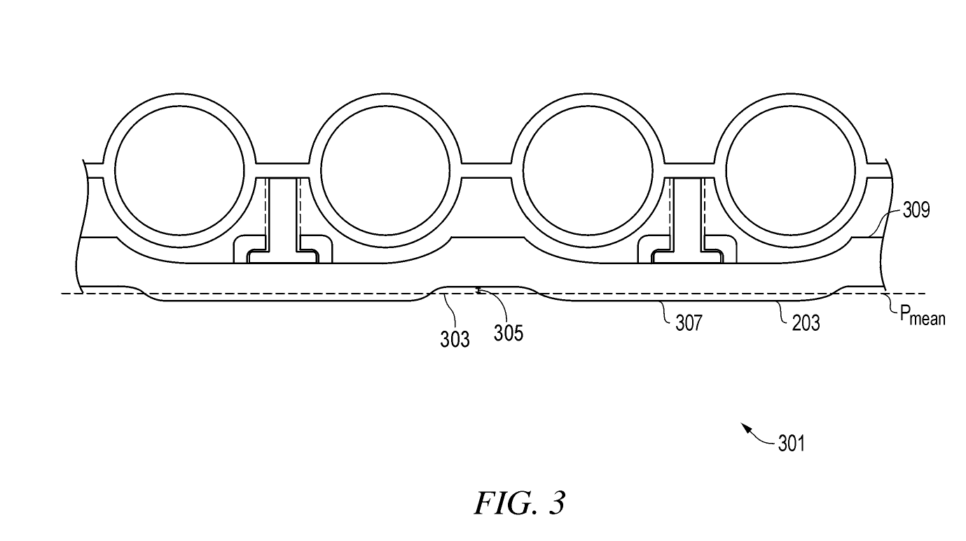

Referring to FIG. 3, a refractory tile 301 having the same cross-sectional contour as FIG. 2 is illustrated. As illustrated, the mean profile line (Pₘₑₐₙ) 303 of the front surface 307 is illustrated. According to the first aspect as described above, the average profile variation (Pₐ) of the front surface is not greater than about 0.75 mm. Stated alternatively, the average variation along the front surface 307 due to the change in contour is not greater than about 0.75 mm from the mean profile line 303. According to another embodiment, the change in profile on the front surface 307 is less, such that the Pₐ is not greater than about 0.70 mm, such as not greater than about 0.60 mm, or even about 0.50 mm. Still, the average profile variation in the front surface can be less, such as not greater than about 0.30 mm. While in one particular embodiment, the front surface 307 is substantially planar and the Pₐ is about zero mm.

In addition to the Pₐ, a maximum change in profile (Pₘₐₓ) of the front surface 307 can also be measured. Generally, the Pₘₐₓ of the front surface 307 (illustrated by line 305) is the greatest measured difference between a highest or lowest point on the front surface and the mean profile line (Pₘₑₐₙ) 303. As such, according to one embodiment, the Pₘₐₓ of the front surface 307 is not greater than about 3.0 mm, such as not greater than about 2.0 mm, or still, not greater than about 1.0 mm. While in one particular embodiment, the front surface 307 is substantially planar such that the Pₘₐₓ is zero mm.

By way of comparison, referring to the prior art refractory tile illustrated in FIG. 1, the average profile variation is much greater given the obvious and dramatic changes in contour. Not only is the average profile variation (Pₐ) of the front surface greater than those described in accordance with embodiments herein, but the Pₘₐₓ value for the prior art tile is also greater.

Like the front surface 307, the back surface 309 can also have an average profile variation (Pₐ). According to one embodiment, aside from the engagement structures, the Pₐ for the back surface 309 is not greater than about 1.0 mm. In another embodiment, the Pₐ is less, such as not greater than about 0.80 mm, or still, not greater than about 0.75 mm, or even 0.50 mm. Still, in one particular embodiment, the back surface 309 can be substantially planar. Additionally, the back surface 309 can have a maximum profile variation (Pₘₐₓ). Generally, the Pₘₐₓ of the back surface 309 is not greater than about 4.0 mm. However, according to other embodiments, the Pₘₐₓ of the back surface 309 is not greater than about 2.0 mm, such as not greater than about 1.0 mm.

It is noted that profile values Pₐ, Pₘₐₓ, Pₘₑₐₙ generally are analogous rₐ rₘₐₓ and rₘₑₐₙ values associated with surface roughness, but that the profile values represent macroscopic surface features generally on the mm scale, rather than roughness values on a much finer scale, such as the micron scale. Like roughness values, the profile values may be measured through characterization of the tiles utilizing a profilometer having a stylus set for macroscopic analysis.

In addition to the profile variations of the front surface 307 and back surface 309, a measure of the maximum change in profile between a point on the front surface that is the greatest distance from a point on the back surface as measured through the thickness of the main body in a direction normal to the plane of the front surface (i.e., the greatest thickness) can be provided. According to one embodiment, the maximum change in profile between the front surface 307 and the back surface 309 is not greater than about 30 mm, such as not greater than about 20 mm, or even not greater than about 15 mm.

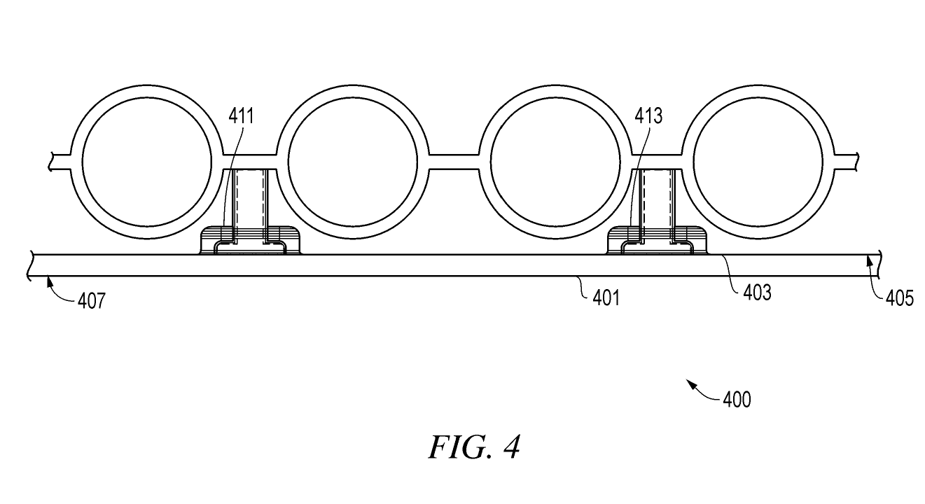

Referring to FIG. 4, another cross sectional view of a refractory tile 400 is illustrated according to one embodiment. As illustrated and according to a particular embodiment, the refractory tile 400 has a substantially planar front surface 401 and a substantially planar back surface 403 (aside from the engagement structures). In addition, the front surface 401 and the back surface 403 are substantially parallel with each other. According to this embodiment, the void plane 405 is substantially coplanar with the back surface 403, since the back surface 403 is substantially flat and without contours. In the illustrated embodiment, the engagement structures 411 and 413 are abutting the back surface and do not extend into the body of the tile, thus the void plane 405 is coplanar with the plane of the back surface 403. In this particular embodiment, the hot face plane 407 is substantially coplanar with the front surface 401, since the front surface 401 is substantially planar and without contours.

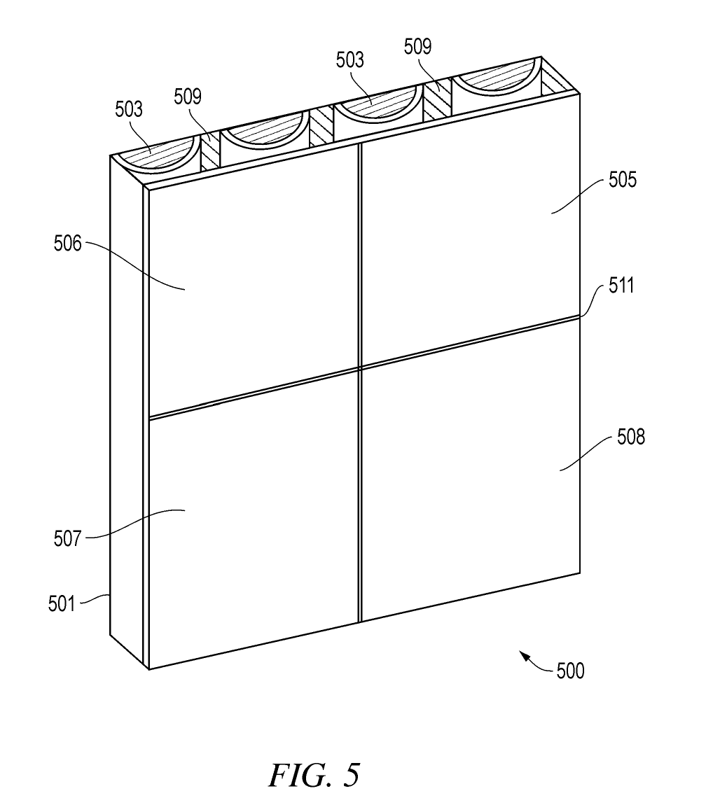

FIG. 5 is a perspective illustration of a plurality of tiles 505, 506, 507, and 508 (505-508) attached to a wall of a boiler 501 which includes a plurality of pipes 503. As illustrated, each of the tiles (505-508) has a substantially planar front surface and is separated by a gap 511. According to one embodiment, the gap between tiles is generally small, such as not greater than about 1.0 cm. In other embodiments, the gap 511 is smaller, such as not greater than about 5.0 mm, or not greater than about 3.0 mm, or still, not greater than about 2.0 mm. Also illustrated, is a gap region 509 behind the tiles 503-508. Generally, this gap region can be filled with a cement, which may be used to modify thermal transfer properties of the system, such as by improving thermal contact between the refractory tiles 505-508 and the wall of the boiler, and to provide additional support for anchoring the tiles 505-508 to the wall 501.

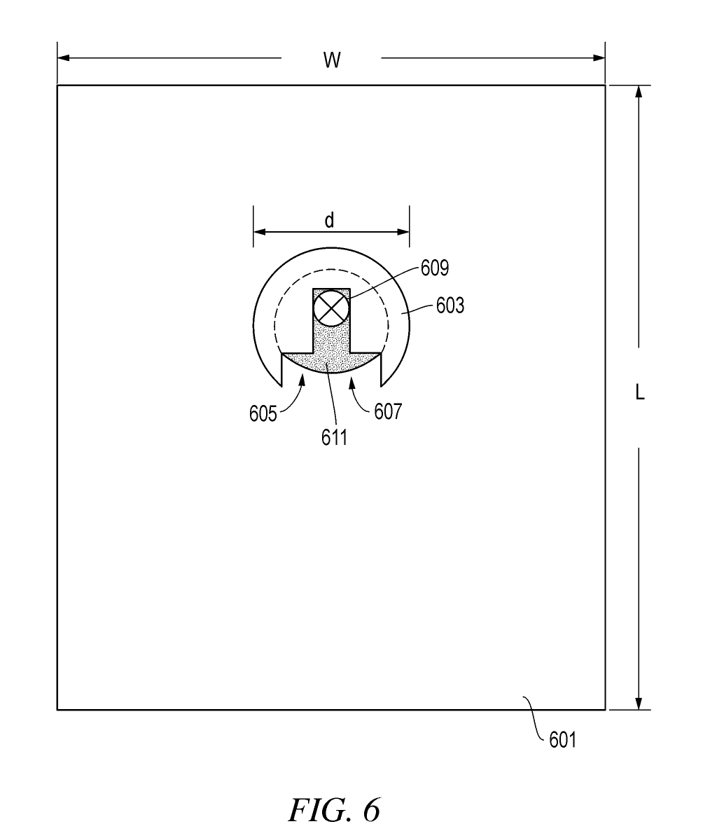

FIG. 6 is a planar view of a refractory tile 601 having an engagement structure 603 according to one embodiment. The refractory tile 601 includes a generally rectangular contour defined by a length (L) and a width (W). According to one embodiment, the refractory tile 601 has dimensions such that the width (W) is less than the length (L), and typically a width (W) that is not greater than about 95% of the length (L). In another embodiment, the width (W) is less, such as not greater than about 90% of the length (L), or not greater than about 80%, or even not greater than about 70% of the length (L). In reference to particular dimensions, typically the tile has a length (L) that is greater than about 10 cm. Other embodiments utilize larger refractory tiles, such that the length (L) is not less than about 15 cm, or not less than about 20 cm, or even not less than about 50 cm. Still, the length (L) of the refractory tile 601 is typically not greater than about 60 cm.

The engagement structure 603 is an alternative engagement structure, notably including a rounded contour and includes an engagement void 605 configured to receive a complementary stud structure 607. In particular, the engagement structure 603 includes an engagement void 605 having a generally rounded contour and accessible for the complementary stud structure 607 via a channel. Accordingly, the engagement void 605 is configured to be slidably engageable with the complementary stud structure 607.

As further illustrated in FIG. 6, the complementary stud structure 607 includes an engagement head 611 coupled to a rod 609, which can extend from the wall of a boiler. As illustrated, the engagement head 611 has a contour complementary to the contour of the engagement void 605 such that when the complementary stud structure 607 engages the engagement structure 603 the engagement head 611 is engaged within the engagement void 605 and typically touching at least one surface within the engagement void 605. More typically, the engagement head 611 is formed such that it engages multiple surfaces within the engagement void 605 for suitable fixation of the refractory tile 601 to the complementary stud 607 and accordingly the wall from which the stud extends. According to a particular embodiment, the engagement structure 603 has a plurality of engagement surfaces that border the engagement void 605 and are configured to contact the complementary stud structure 607 and secure the refractory tile 601 in one location. As previously described, the engagement surfaces within the engagement void 605 are suitable for limiting the motion of the tile in lateral directions and a vertical direction. According to one particular embodiment, the engagement structure 603 is configured engage a complementary stud structure along multiple surfaces, and more particularly engages a stud structure such that there are substantially no gaps between the engagement structure and the complementary stud structure.

The dimensions of the engagement structure 603 are similar to those described above in accordance with other embodiments. Notably, the diameter (d) of the rounded engagement structure 603 has dimensions substantially similar to the width of previously described engagement structures. As such, generally the diameter (d) of the engagement structure 603 is not greater than about 25% of the length (L) of the refractory tile 601. Other embodiments utilize a smaller engagement structure, such that the diameter of the engagement structure 603 is not greater than about 20%, or even not greater than about 15% of the length (L) refractory tile 603. Having engagement structures of a discrete diameter (d) that is a portion of the length (L) of the tile facilitates anchoring the tile at a single point which can allow for movement of the tile about an anchoring point.

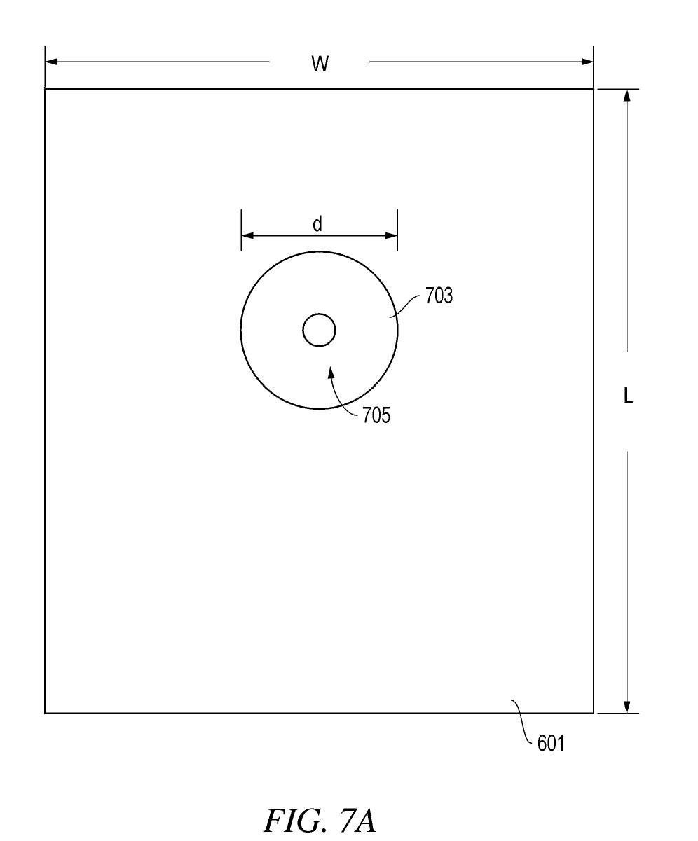

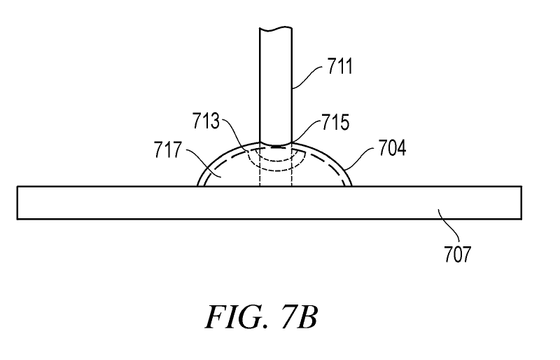

Referring to FIG. 7, a planar view of a refractory tile 701 and an engagement structure 703 is provided. The refractory tile 701 includes a generally rectangular contour defined by a length (L) and a width (W). As provided above, the length (L) and the width (W) of the tile may be such that the width (W) is a portion of the dimensions of the length (L), such as not greater than about 95% of the length (L). In another embodiment, the width (W) is less, such as not greater than about 90% of the length (L), or not greater than about 80%, or even not greater than about 70% of the length (L). In particular reference to dimensions of the refractory tile 701, typically the tile has a length that is greater than about 10 cm. Other embodiments may utilize a refractory tile having greater dimensions, such that the length is not less than about 15 cm, or not less than about 20 cm, or even not less than about 50 cm. Still, the length (L) of the refractory tile 701 is typically not greater than about 60 cm.

The engagement structure 703 is adjacent to the surface of the refractory tile 701 and projects away from the surface of the tile. The engagement structure 701 has a rounded contour and includes an engagement void 705 configured to receive a complementary stud structure (not illustrated). In particular, the engagement structure 703 includes an engagement void 605 in the form of a hole, thereby creating a pocket within the engagement structure 703 for engagement of a complementary stud structure. Accordingly, the engagement void 605 is configured to be engageable with a complementary stud structure such that the stud structure is pushed through the engagement void 705 and secured within the engagement structure 703. According to one particular embodiment, the complementary stud structure can include one or more engagement flanges which may be deformed upon passage through the engagement void 703 thereby securing the stud structure within the engagement structure 703. One form of a suitable engagement flange can include for example, a washer (or alternatively a plurality of washers) placed around the stud structure which deform when passing through the engagement void 705, for example by forming conical shapes, and securing the refractory tile 701.

The dimensions of the engagement structure 703 are similar to those described above in accordance with other embodiments. As such, generally the diameter (d) of the engagement structure 703 is not greater than about 25% of the length (L) of the refractory tile 701. Other embodiments utilize a smaller engagement structure 703, such that the diameter (d) of the engagement structure 603 is not greater than about 20%, or even not greater than about 15% of the length (L) refractory tile 603. Having engagement structures of a discrete diameter (d) that is a portion of the length (L) of the tile facilitates anchoring the tile at a single point which can allow for movement of the tile about an anchoring point.

Referring to FIG. 7A, a side view of a refractory tile 707 and an engagement structure 709 are illustrated. Notably, the illustrated engagement structure 709 includes an engagement void 715 in the form of a hole, thereby creating a pocket 717 within the engagement structure 709 for engagement of the complementary stud structure 710. As illustrated, the complementary stud structure 710 includes a rod portion 711 and an engagement head 713. As described above, in this embodiment the engagement structure 709 and the complementary stud structure 710 are configured to be pushably engageable, such that the engagement head 713 may deform upon passage through the engagement void 715 thereby securely coupling the refractory tile 707 and complementary stud structure 710. According to the illustrated embodiment, this particular engagement head 713 includes a washer structure which has been deformed upon passage through the engagement void 715. As provided above, while one engagement head 713 is illustrated, other embodiments can utilize more than one engagement head.

The foregoing description has illustrated various embodiments of refractory tile assemblies including refractory tile structures coupled with engagement structures suitable for attaching the tiles to complementary stud structures. Notably, such assemblies can be monolithic or modular. That is, the combination of the refractory tile and the engagement structure can be a monolithic article such that the tile and engagement structure are a single piece. Alternatively, the tile and engagement structure can have a modular design, such that the tile and engagement structure are separate pieces that can be placed together, for example in an interlocking arrangement, and used jointly to form a refractory tile assembly. A modular design facilitates coupling of select tiles and select engagement structures for use in particular applications.

In comparison with prior refractory tile systems, such as that shown in FIG. 1, embodiments of the present invention can provide notable advantages. For example, according to several embodiments, the architecture of the tiles helps protect wall stud structures from undesirable thermal and chemical attack, such as by configuring the engagement structure and engagement void such that the wall stud structures are displaced from the front (hot) face of the tiles. Such architectures are particularly desirable in combination with certain refractory tile materials, having material properties or compositions described herein. In this respect, such compositions can be effective to improve thermal transfer and exacerbate degradation of wall stud structures, and the architectural details of embodiments herein can attenuate the otherwise increased degradation of wall stud structures. In addition, backside displacement of the engagement voids and associated wall stud structures can improve uniformity of thermal gradients through the body of the tiles, further improving tile life through reduction of thermal stresses in the structure.

Still further, according to various embodiments, one or both the front and back surfaces may have reduced contour, and may indeed be generally planar. Such a structure, in combination with particular materials can notably improve performance during use, manifested by reduced build-up of slag and improved longevity though reduction of non-uniform thermal gradients along the tiles. The combination of reduced front surface contour and a material of a certain material property (e.g., density, or thermal conductivity) or composition (e.g., metal/ceramic composition) can improve gas flow along the hot face, providing a washing effect along the hot face. Still further, relative movement between the tiles and underlying cement can be improved according to embodiments, such as through use of a dense tile (low porosity), which may also have a reduced contour back surface (which contacts such cement).

Additionally, the use of particular engagement structures can improve durability by reducing crack initiation associated with prior art designs that rely on a rack or rail system to secure tiles vertically. Such engagement structures are notable in the context of certain materials as disclosed herein, as such materials, due to increased thermal transfer can exacerbate cracking.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A refractory tile system for covering a wall of a boiler, comprising:
a plurality of tiles adapted for assembly to cover the wall of the boiler, each tile including:
a main body having a front surface and a back surface, wherein the main body comprises a composite material including silicon carbide and a metallic phase including silicon;
first engagement structure extending from the back surface of the tile and having a first engagement void for receiving a complementary stud structure extending from the wall of the boiler;
a void plane defined by a plurality of void points, wherein the void points are points within the first engagement void that are closest to the front surface and extend along the first engagement void; and
a hot face plane parallel to the void plane and defined by a plurality of hot face points, each hot face point being located on the front surface closest to the void plane, wherein Dₛ>0.25 Tₐ, Dₛ being shortest distance between the void plane and the hot face plane and Tₐ being the average thickness of the main body.

2. The refractory tile system of claim 1, wherein Dₛ>0.50 Tₐ.

3-4. (canceled)

5. The refractory tile system of claim 1, wherein the void plane does not intersect any points on the front surface.

6-8. (canceled)

9. The refractory tile system of claim 1, wherein the front surface has a maximum change in profile (Pₘₐₓ) of not greater than about 3.0 mm.

10. The refractory tile system of claim 1, wherein the back surface has a Pₐ of not greater than about 1.0 mm

11-14. (canceled)

15. The refractory tile system of claim 1, wherein the first engagement structure is configured to bear a load of not less than the full weight of the tile.

16. The refractory tile system of claim 1, wherein the first engagement structure is configured to engage the complementary stud structure and substantially restrict movement of the tile in a lateral direction.

17. The refractory tile system of claim 1, wherein the first engagement structure is configured to engage the complementary stud structure and substantially restrict movement of the tile in the same direction as the vector of the load exerted on the complementary stud structure by the weight of the tile.

18. The refractory tile system of claim 1, wherein the first engagement void has a discrete length and width less than the full length and width of the tile respectively.

19-20. (canceled)

21. The refractory tile system of claim 1, wherein the first engagement void has a substantially T-shaped cross-sectional contour.

22. The refractory tile system of claim 1, wherein the first engagement structure is configured to engage the complementary stud structure such that the complementary stud structure abuts the void plane within the engagement void.

23. The refractory tile system of claim 22, wherein the first engagement structure is configured to engage the complementary stud structure such that the complementary stud structure abuts the back surface of the tile.

24. The refractory tile system of claim 1, wherein Tₐ is not greater than about 30 mm.

25. (canceled)

26. The refractory tile system of claim 1, wherein the main body has a porosity of not greater than about 5.0 vol %.

27. (canceled)

28. The refractory tile system of claim 1, wherein the main body comprises not less than about 80 wt % SiC.

29. (canceled)

30. The refractory tile system of claim 1, wherein the main body comprises not greater than about 30 wt % silicon.

31-35. (canceled)

36. The refractory tile system of claim 1, wherein each tile is configured to have a gap between adjacent tiles not greater than about 1.0 cm, in assembled form.

37. A refractory tile system for covering a wall of a boiler, comprising:
a plurality of tiles adapted for assembly to cover the wall of the boiler, each tile including:
a main body having a front surface and a back surface, wherein the main body is a composite material including silicon carbide and a metallic phase including silicon, and wherein the front surface has an average profile variation (Pₐ) of not greater than about 0.75 mm; and
an engagement structure extending from the back surface of the tile and having an engagement void for receiving a complementary stud structure extending from the wall of the boiler.

38. The refractory tile system of claim 37, wherein each tile comprises a plurality of engagement structures.

39-40. (canceled)

41. The refractory tile system of claim 37, wherein the engagement structure extends from the back surface and the engagement void terminates at the back surface so as not to extend into the main body.

42-48. (canceled)

49. The refractory tile system of claim 37, wherein the front surface has a Pₐ of not greater than about 0.50 mm.

50-55. (canceled)

56. The refractory tile system of claim 37, wherein the tile has a maximum change in profile between the highest point on the front surface and the lowest point on the back surface not greater than about 30 mm.

57. The refractory tile system of claim 56, wherein the back surface and the front surface are substantially parallel planes.

58. A refractory tile system for covering a wall of a boiler, comprising:
a plurality of tiles adapted for assembly to cover the wall of the boiler, each tile including:
a main body having a front surface and a back surface, wherein the main body has a thermal conductivity of not less than about 18 W/mK at 1200° C.;
first and second engagement structures extending from the back surface of the tile and having respective first and second engagement voids for receiving complementary stud structures extending from the wall of the boiler;
a void plane defined by a plurality of void points, wherein the void points are points within the first and second engagement voids that are closest to the front surface and extend along the first and second engagement voids; and
a hot face plane parallel to the void plane and defined by a plurality of hot face points, each hot face point being located on the front surface closest to the void plane, wherein Dₛ>0.25 Tₐ, Dₛ being shortest distance between the void plane and the hot face plane and Tₐ being the average thickness of the main body.

59-61. (canceled)

62. The refractory tile system of claim 58, wherein the main body has a thermal conductivity of not less than about 20 W/mK at 1200° C.

63-64. (canceled)

65. The refractory tile system of claim 58, wherein the main body is a composite material comprising silicon carbide and a metallic phase including silicon.

66. The refractory tile system of claim 58, wherein the main body has a bulk density of not less than about 2.85 g/cm³.

67-74. (canceled)
